(19) United States
(12) Patent Application Publication
(10) Pub. No.: US 2011/0103705 A1
(43) Pub. Date: May 5, 2011

(54) IMAGE ENCODING METHOD AND APPARATUS, AND IMAGE DECODING METHOD AND APPARATUS

(75) Inventors: Yong-ju Lee, Seoul (KR); Hyun-seok Hong, Suwon-si (KR); Yang-lim Choi, Seongnam-si (KR); Jin-gu Jeong, Ansan-si (KR)

(73) Assignee: SAMSUNG ELECTRONICS CO., LTD., Suwon-si (KR)

(21) Appl. No.: 12/939,698

(22) Filed: Nov. 4, 2010

(30) Foreign Application Priority Data
Nov. 4, 2009 (KR) 10-2009-0105980

(51) Int. Cl. G06K 9/46; G06K 9/00

(52) U.S. Cl. 382/251; 382/232

(57) ABSTRACT

An image encoding method and an image decoding method, the image encoding method including: degrading a quality of a first image which is obtained through a sensor of an imaging device to generate a second image having a target resolution; generating additional information which represents a transform relationship between the first and second images; and transmitting the additional information and the second image.

### CROSS-REFERENCE TO RELATED PATENT APPLICATION

This application claims priority from Korean Patent Application No. 10-2009-0105980, filed on Nov. 4, 2009 in the Korean Intellectual Property Office, the disclosure of which is incorporated herein in its entirety by reference.

### BACKGROUND

1. Field

Apparatuses and methods consistent with the exemplary embodiments relate to an image encoding method and apparatus, and an image decoding method and apparatus.

2. Description of the Related Art

Recently, as information communication technologies advance, users' requirements for high-quality images are increasing. Therefore, display devices such as televisions (TV) providing high-quality images are needed.

However, since the capacity of a high-quality image is large, a broad transmission band or a large storage space is required for receiving or storing the high-quality image. Accordingly, a method which acquires a high-quality image from a low-quality image, when a user requires the high-quality image after storing the low-quality image, is widely being used.

### SUMMARY

Exemplary embodiments provide an image encoding method and apparatus, and an image decoding method and apparatus.

According to an aspect of an exemplary embodiment, there is provided a method of encoding an image, the method including: degrading a quality of a first image which is obtained through a sensor of an imaging device to generate a second image having a target resolution; generating additional information including a transform relationship between the first and the second images; and transmitting the additional information and the second image.

The generating the additional information may include: scaling the second image to generate a third image having a same resolution as the first image; and generating a differential image between the third image and the first image as the additional information.

The generating the additional information may include: determining a portion of the first image as a region of interest; and generating a transform relationship between the region of interest and a correspondence region of the second image that corresponds to the region of interest, as the additional information.

The determining the portion may include determining, as the region of interest, a region of the first image where a degree of restoration representing a matching degree between the first image and an image into which the second image is restored is equal to or less than a critical value.

The determining the region may include determining the region of interest on the basis of a user's input that is received through an interface.

The determining the region may include determining a region, which comprises an object component, as the region of interest.

The method may further include: quantizing the generated additional information; and compressing the quantized additional information.

According to an aspect of another exemplary embodiment, there is provided a method of decoding an image including: obtaining a second image which is generated by degrading a quality of a first image which is obtained through a sensor of an imaging device, and additional information which includes a transform relationship between the first and the second images; and restoring the second image into the first image on the basis of the additional information.

The additional information may include a differential image between the first image and a third image which is generated by scaling the second image, and the restoring the second image may include: scaling the second image to obtain the third image; and restoring the first image by using the third image and the differential image.

The additional information may include a transform relationship between a region of interest being a portion of the first image and a correspondence region of the second image that corresponds to the region of interest, and the restoring the second image may include restoring the correspondence region of the second image on the basis of the additional information.

The region of interest may include a region where a degree of restoration representing a matching degree between the first image and an image into which the second image is restored is equal to or less than a critical value.

The region of interest may include a region which is selected according to a user's input that is received through an interface.

The region of interest may include an object component.

The restoring the second image may include: decompressing the additional information; and dequantizing the decompressed additional information.

According to an aspect of another exemplary embodiment, there is provided an apparatus for encoding an image including: a sensor which obtains a first image; an image generation unit which degrades a quality of the first image to generate a second image; an additional information generation unit which generates additional information including a transform relationship between the first and the second images; and a transmission unit which transmits the additional information and the second image.

According to an aspect of another exemplary embodiment, there is provided an apparatus for encoding an image including: an obtainment unit which obtains a second image which is generated by degrading a quality of a first image which is obtained through a sensor of an imaging device, and additional information including a transform relationship between the first and the second images; and a restoration unit which restores the second image into the first image on the basis of the additional information.

According to an aspect of another exemplary embodiment, there is provided an image encoding and decoding method including: degrading, by an image encoding apparatus, a quality of a first image which is obtained through a sensor of an imaging device to generate a second image having a target resolution; generating, by the image encoding apparatus, additional information comprising a transform relationship between the first image and the second image; transmitting, by the image encoding apparatus, the additional information and the second image; receiving, by an image decoding apparatus, the second image and the additional information; and restoring, by the image decoding apparatus, the second image into the first image according to the additional information.

### BRIEF DESCRIPTION OF THE DRAWINGS

The above and other features and advantages will become more apparent by describing in detail exemplary embodiments thereof with reference to the attached drawings in which:

FIG. 1 is a block diagram illustrating an image encoding apparatus and an image decoding apparatus, according to an exemplary embodiment;

FIG. 2 is a block diagram illustrating an image encoding apparatus and an image decoding apparatus, according to another exemplary embodiment;

FIG. 3 illustrates a first image, a second image and a third image, according to an exemplary embodiment;

FIGS. 4A and 4B illustrate images as examples of additional information, according to exemplary embodiments;

FIG. 5 illustrates an example of pixel values of respective images according to an exemplary embodiment;

FIG. 6 is a flowchart illustrating an image encoding method according to an exemplary embodiment; and

FIG. 7 is a flowchart illustrating an image decoding method according to an exemplary embodiment.

### DETAILED DESCRIPTION OF THE EXEMPLARY EMBODIMENTS

Exemplary embodiments will now be described more fully with reference to the accompanying drawings, in which like drawing reference numerals are used for similar elements throughout. Expressions such as “at least one of,” when preceding a list of elements, modify the entire list of elements and do not modify the individual elements of the list.

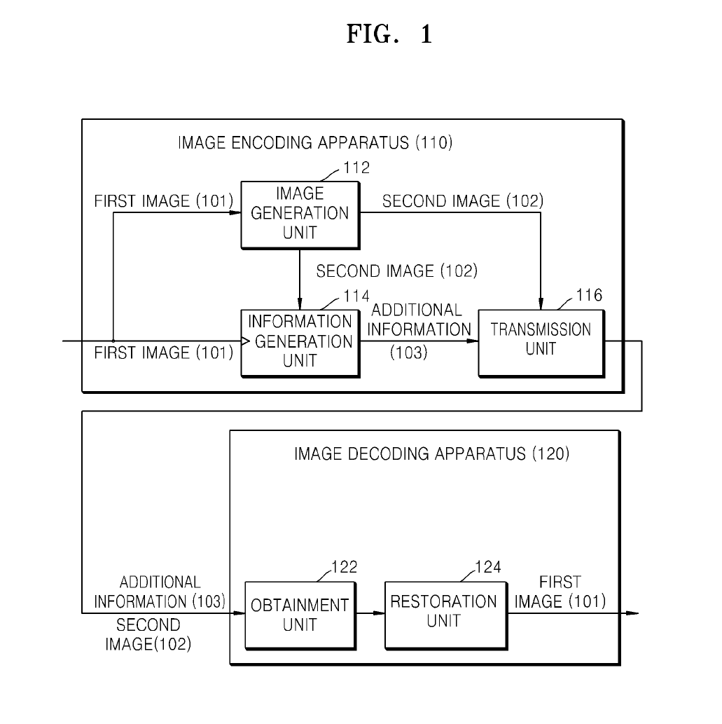

FIG. 1 is a block diagram illustrating an image encoding apparatus 110 and an image decoding apparatus 120, according to an exemplary embodiment. Referring to FIG. 1, the image encoding apparatus 110 includes an image generation unit 112, an information generation unit 114, and a transmission unit 116.

The image generation unit 112 degrades a quality of a first image 101 that is obtained through a sensor included in an imaging device to generate a second image 102 having a target resolution. Generally, the first image 101 that is obtained through the sensor included in the imaging device is a high-quality image. The high-quality image may be stored as is, or may be transformed into a lower-quality image and is thereby stored. As an example, it is assumed that a first image 101 of a 2592×1944 resolution is obtained through the sensor of a photographing device. For storing a high-quality first image 101, since a large storage space is required, a user may request transforming the first image 101 into a second image 102 to store the transformed image 102. In this case, the image generation unit 112 may degrade the quality of the first image 101 having a 2592×1944 resolution to generate a second image 102 of a 1920×1080 resolution.

As another example, a first image 101 of a 2592×1944 resolution is obtained through the sensor of a photographing device, but it is assumed that the resolution of an image to be reproduced through a high definition (HD) television (TV) is limited to 1280×720 pixels according to a predefined standard. In this case, when a user intends to reproduce the first image 101 through the HD TV, the image generation unit 112 may degrade the quality of the first image 101 to generate a second image 102 of a 1280×720 resolution.

The information generation unit 114 generates additional information 103 that represents a transform relationship between the first image 101 and the second image 102. In the present disclosure, a transform relationship denotes a relationship between the first and second images 101 and 102 when transforming the first image 101 into the second image 102 or transforming the second image 102 into the first image 101. As an example, the additional information 103 may include at least one of an algorithm that is used when the image generation unit 112 generates the second image 102, a differential image between the first and second images 101 and 102 (or a differential image between the first image 101 and a third image which is a scaled image of the second image 102), and a pattern difference between the first and second images 101 and 102. The additional information 103 is used when a restoration unit 124 to be described below restores the first image 101 using the second image 102. Hereinafter, for convenience, it is assumed that the additional information 103 includes the differential image between the first image 101 and a third image which is a scaled image of the second image 102, though it is understood that another exemplary embodiment is not limited thereto.

The additional information 103 may include the transform relationship between all regions of the first image 101 and all regions of the second image 102, or may include only the transform relationship between a portion of the first image 101 and a portion of the second image 102 (or a portion of the third image which is a scaled second image). In the present disclosure, for convenience, a region of the first image 101 including relationship information with the second image 102 (or the third image) is called a region of interest, and a region of the second image 102 corresponding to the region of interest is called a correspondence region.

A method for determining a region of interest may variously be implemented according to various exemplary embodiments. As an example, a user may directly or manually designate the region of interest. Specifically, the user directly selects a region to completely be restored into high quality in a first image 101 or a second image 102. The information generation unit 114 determines the region selected by the user as a region of interest, and generates a differential image, which represents a difference between a pixel value corresponding to the region of interest and a pixel value corresponding to a correspondence region, as additional information 103. At this point, by allowing pixels that do not correspond to the region of interest and pixels that do not correspond to the correspondence region to have the same pixel value, the pixel values of corresponding pixels may be marked as 0 in the differential image.

As another example, the information generation unit 114 may determine a region, in which a degree of restoration that represents a matching degree between the first image 101 and an image into which a second image 102 is restored is equal to or less than a critical value, as a region of interest. That is, when restoring the second image 102, the information generation unit 114 may determine a region that is difficult to restore as a region of interest. For example, the information generation unit 114 may directly restore the second image 102 and compare the restored image 102 with the first image 101, thereby detecting a region that is difficult to restore. In another exemplary embodiment, the information generation unit 114 may analyze at least one of the pixel, gradient and Laplacian of the first image 101 even without restoring the second image 102, thereby detecting the region that is difficult to restore. Generally, it is difficult to restore a region, having a narrow dynamic range of an edge component or brightness component of the first image 101, into a high-quality image. Accordingly, the information generation unit 114 may analyze the first image 101 and determine, as a region of interest, a region having a small dynamic range of an edge or brightness component.

As another example, the information generation unit 114 may determine a region including an object component of a first image 101 as a region of interest. Particularly, the information generation unit 114 may determine a region including a specific object component as a region of interest. As an example, the information generation unit 114 may determine, as a region of interest, a region that includes a moving object component or an object component representing important information such as characters or figures.

The transmission unit 116 transmits the additional information 103 and the second image 102. When a user intends to store the second image 102, the transmission unit 116 transmits the additional information 103 and the second image 102 to a storage space such as a memory. When the user intends to reproduce the second image 102, the transmission unit 116 transmits the additional information 103 and the second image 102 to an output device such as a display unit. Moreover, the transmission unit 116 may transmits the additional information 103 and the second image 102 to an external device over a wired network such as a Local Area Network (LAN) or a wireless network such as Wibro and High Speed Packet Data Access (HSPDA). In another exemplary embodiment, the additional information 103 and the second image 102 may be post-processed, such as quantization and compression, and be transmitted.

The image decoding apparatus 120 according to an exemplary embodiment includes an obtainment unit 122 and the restoration unit 124.

The obtainment unit 122 obtains the second image 102 and the additional information 103. The second image 102 is an image that is generated by degrading the quality of the first image 101 which is obtained through a sensor included in an imaging device. The additional information 103 is information that represents the transform relationship between the first and second images 101 and 102, as described above. The obtainment unit 122 may read out the second image 102 and the additional information 103 from a storage space such as a memory or a disk, or may receive the second image 102 and the additional information 103 over a wired/wireless network.

The restoration unit 124 restores the second image 102 into the first image 101 on the basis of the additional information 103. A method in which the restoration unit 124 restores the second image 102 into the first image 101 may vary according to the kind of the additional information 103. Hereinafter, it is assumed that the additional information 103 includes a differential image between the first image 101 and the third image that is generated by scaling the second image 102.

In this case, the restoration unit 124 scales the second image 102 in order to have the same resolution as that of the first image 101, thereby obtaining the third image. As an example, the restoration unit 124 may scale the second image 102 using an interpolation scheme. Subsequently, the restoration unit 124 adds a differential image to the third image to obtain the first image 101. If the differential image includes only the transform relationship between a portion (i.e., region of interest) of the first image 101 and a portion (i.e., correspondence region) of the region of the third image, a pixel value that does not correspond to a corresponding region may be allocated as 0. Accordingly, a portion of the region of the restored image corresponds to a high-quality image, and other regions correspond to a lower-quality image.

A case in which a high-quality image that is obtained through a sensor of an imaging device, such as a camera, according to a restriction of a resource such as a memory and to a compliance standard is transformed into a lower-quality image and is thereby stored occurs sometimes. According to a related art image decoding apparatus, it is impossible to completely restore a low-quality image into a high-quality image. However, by storing a lower-quality image and a relationship information between a high-quality image and the lower-quality image before deleting the high-quality image, the image decoding apparatus 120 according to an exemplary embodiment can completely restore the lower-quality image into the high-quality image when a user desires the high-quality image later. Particularly, by storing only information on a portion of the lower-quality image that is difficult to restore, the image decoding apparatus 120 can efficiently restore the lower-quality image into the high-quality image even when size of the additional information is restricted.

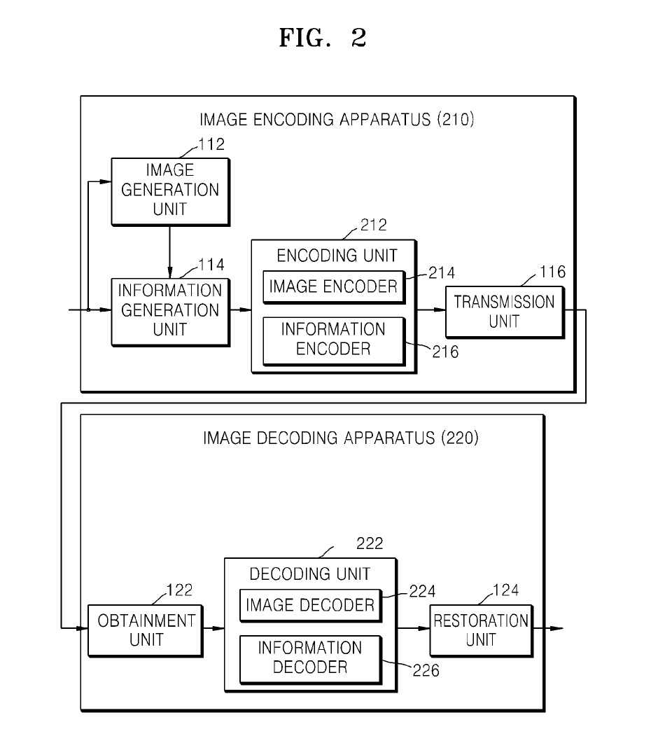

FIG. 2 is a block diagram illustrating an image encoding apparatus 210 and an image decoding apparatus 220, according to another exemplary embodiment. Referring to FIG. 2, the image encoding apparatus 210 includes an image generation unit 112, an information generation unit 114, an encoding unit 212, and a transmission unit 116. Except for the encoding unit 212, since the image encoding apparatus 110 of FIG. 1 and the image encoding apparatus 210 of FIG. 2 have a similar configuration, the following description will focus on the encoding unit 212.

The encoding unit 212 may include an image encoder 214 and an information encoder 216.

The image encoder 214 encodes a second image. Specifically, the image encoder 214 encodes the second image using at least one of various encoding schemes such as entropy coding and variable length encoding.

The information encoder 216 encodes additional information. The information encoder 216 may include a quantizer (not shown) and a compressor (not shown). The quantizer (not shown) quantizes the additional information. The quantizer (not shown) may increase a quantization interval for decreasing the size of the additional information or decrease the quantization interval for delicately restoring the first image. The compressor (not shown) performs lossy compression or non-lossy compression on the quantized additional information.

The image decoding apparatus 220 includes an obtainment unit 122, a decoding unit 222 and a restoration unit 124. Except for the decoding unit 222, since the image decoding apparatus 120 of FIG. 1 and the image decoding apparatus 220 of FIG. 2 have a similar configuration, the following description will focus on the decoding unit 222.

The decoding unit 222 may include an image decoder 224 and an information decoder 226.

The image decoder 224 decodes a second image. Specifically, the image decoder 224 decodes the second image through a decoding scheme corresponding to an encoding scheme that is used in the image encoder 214.

The information decoder 226 decodes additional information. The information decoder 224 may include a decompressor (not shown) and a dequantizer (not shown). The decompressor decompresses the additional information. The dequantizer dequantizes the decompressed additional information to obtain additional information before encoding.

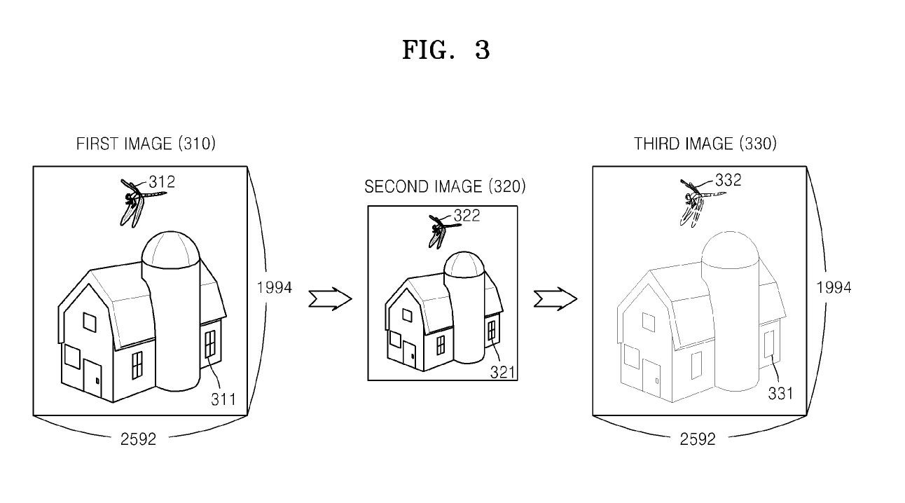

FIG. 3 illustrates a first image 310, a second image 320 and a third image 330, according to an exemplary embodiment.

The first image 310 is a high-quality image that is obtained through a sensor of an imaging device, and has a 2592×1994 resolution.

The second image 320 is generated by degrading the quality of the first image 310. For example, the second image 320 may have a resolution that is desired by a user or complies with a standard. In FIG. 3, it is assumed that the second image 320 has a 1920×1080 resolution.

The third image 330 is a scaled image of the second image 320 in order to have the same resolution as that of the first image 310. The third image 330 may be generated by interpolating new pixels into pixels of the second image 320. An interpolation scheme that is used in generating the third image 330 may vary according to various exemplary embodiments.

When generating the second image 320 from the first image 310, some pixels are deleted. Although deleted pixel components are estimated using peripheral pixels, it may be impossible to completely restore the deleted pixels. Particularly, it may be impossible to completely restore an edge component. Accordingly, the third image 330 has an unclear boundary and becomes more dim than the first image 310. As an example, a bar 311 of a window is clearly shown in the first image 310. However, the bar 331 of the window is less clearly shown in the third image 330.

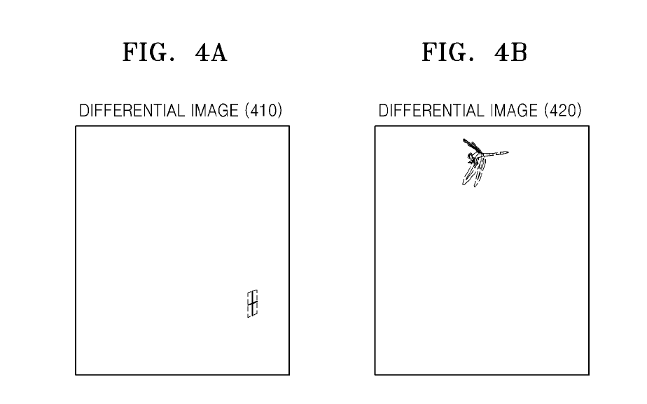

FIGS. 4A and 4B illustrate images as examples of additional information according to exemplary embodiments. In FIGS. 4A and 4B, it is assumed that additional information includes a differential image 410 between the first image 310 and the third image 330 that is generated by scaling the second image 320. Moreover, it is assumed that the differential image 410 is generated through differentiation between a region of interest being a portion of the region of the first image 310 and the correspondence region of the third image 330 that corresponds to the region of interest.

In FIG. 4A, when restoring the second image 320 into the first image 310, a region in which a degree of restoration is equal to or less than a critical value is set as a region of interest. Comparing the third image 330, which is a scaled image of the second image 320, and the first image 310, which is the original image, it can be seen that the bars 311 and 331 of the windows have the greatest difference. Accordingly, the bar 311 is set as a region of interest, and the bar 331 is set as a correspondence region.

The information generation unit 114 differentiates a pixel value corresponding to the region of interest and a pixel value corresponding to the correspondence region to generate a differential image 410. At this point, the pixel of a region that does not correspond to the region of interest or the correspondence region has a value of 0.

In FIG. 4B, a region including a moving object in the first image 310 is set as a region of interest. The moving object in the first image 310 is a dragonfly 312. Therefore, a region including the dragonfly 312 in the first image 310 is set as the region of interest, and a region including the dragonfly 332 in the third image 330 is set as a correspondence region.

The information generation unit 114 differentiates a pixel value corresponding to a region of interest and a pixel value corresponding to a correspondence region to generate a differential image 420. At this point, the pixel of a region that does not correspond to the region of interest or the correspondence region has a value of 0.

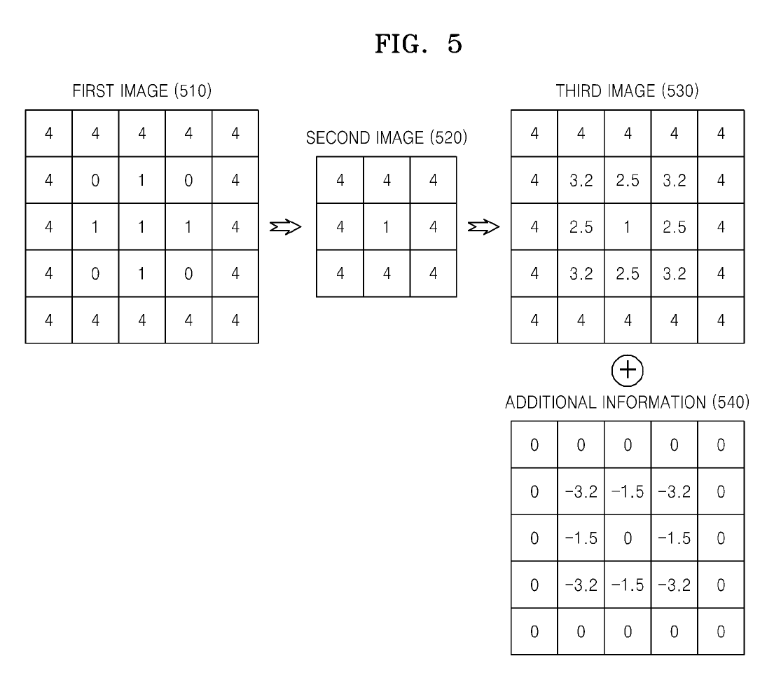

FIG. 5 illustrates an example of pixel values of respective images, according to an exemplary embodiment. For convenience of description, only value of pixels corresponding to a bar of a window in FIG. 3 will be described below.

Referring to FIG. 5, a first image 510 is a high-quality image that is obtained through a sensor, and has a 5×5 resolution.

A second image 520 is generated by degrading the quality of the first image 510, and has a 3×3 resolution. A method in which the image generation unit 112 generates the second image 520 may vary according to various exemplary embodiments. In FIG. 5, however, it is assumed that the second image 520 is generated using only the pixels of coordinates (1,1), (1,3), (1,5), (3,1), (3,3), (3,5), (5,1), (5,3) and (5,5) among pixels configuring the first image 510.

A third image 530 is a scaled image of the second image 520 in order for the second image 520 to have the same resolution as that of the first image 510. A method of scaling the second image 520 may vary according to various exemplary embodiments. In FIG. 5, however, the third image 530 is generated by interpolating new pixels into the second image 520. At this point, it is assumed that the interpolated pixels have an average value of adjacent left and right pixels. As an example, a pixel disposed at coordinates (1,2) in the third image 530 has, as a pixel value, the average value of a pixel disposed at coordinates (1,1) in the second image 520 and a pixel disposed at coordinates (1,3) in the second image 520. Accordingly, a pixel disposed at coordinates (1,2) in the third image 530 has a value of 4.

The pixel values of the third image 530 and the pixel values of the first image 510 are different from each other. Although new pixels are interpolated into the second image 520, the interpolated pixel values are merely estimated on the basis of the values of peripheral pixels, and therefore may differ from the pixel value of the original image. Accordingly, distortion results in the third image 530.

The information generation unit 114 generates an image, which is obtained by differentiating the third image 530 from the first image 510, as additional information 540. Subsequently, the image decoding apparatus 120 scales the second image 520 and adds the additional information 540, thereby completely restoring the first image 510.

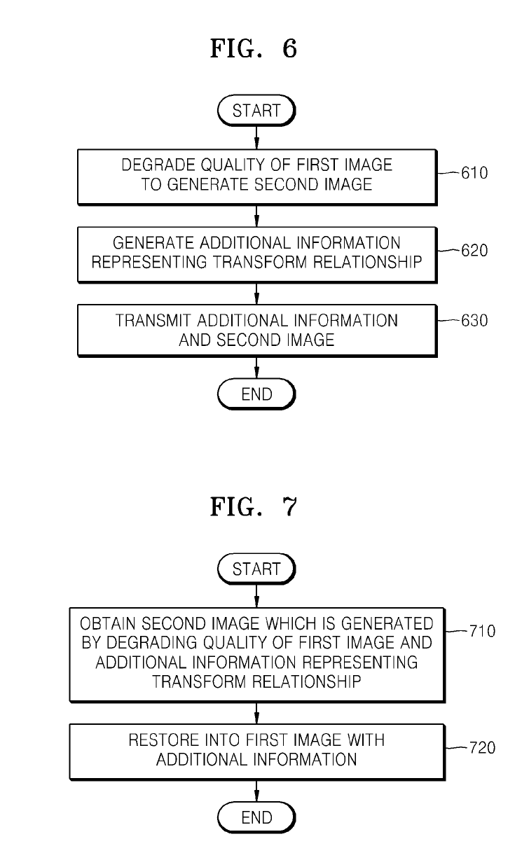

FIG. 6 is a flowchart illustrating an image encoding method according to an exemplary embodiment. Referring to FIG. 6, the image encoding apparatus degrades a quality of a first image that is obtained through a sensor included in an imaging device to generate a second image having a target resolution, in operation S610.

The image encoding apparatus generates additional information that represents a transform relationship between the first and the second images, in operation S620. As an example, the additional information may include at least one of a differential image between the first image and the second image (or a third image which is a scaled second image), pattern changing information between the first and the second images, and algorithm information that is used in generating the second image.

The additional information may include the transform relationship between all regions of the first image and all regions of the second image, or may include the transform relationship between only a region of interest of the first image and a correspondence region of the second image that corresponds to the region of interest.

A method that determines a region of interest or a correspondence region may vary according to various exemplary embodiments. As an example, a user may directly select a region of interest, analyze the first image or the second image without a user's input to determine a region including a desired object as a region of interest, or determine a region that is difficult to restore as a region of interest when restoring the first image from the second image.

The image encoding apparatus transmits the additional information and the second image, in operation S630.

FIG. 7 is a flowchart illustrating an image decoding method according to an exemplary embodiment. Referring to FIG. 7, the image decoding apparatus obtains a second image that is generated by degrading a quality of a first image which is obtained through a sensor included in an imaging device, and additional information that represents the transform relationship between the first and the second images.

The image decoding apparatus restores the second image into the first image on the basis of the additional information, in operation S720.

While not restricted thereto, exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media. The computer readable recording medium can also be distributed over network-coupled computer systems so that the computer-readable code is stored and executed in a distributed fashion. Also, the exemplary embodiments may be written as computer programs transmitted over a computer readable transmission medium, such as a carrier wave, and received and implemented in general-use digital computers that execute the programs. Moreover, while not required in all aspects, one or more units of the image encoding apparatus 110 or 210 or the image decoding apparatus 120 or 220 can include a processor or microprocessor executing a computer program stored in a computer-readable medium.

While has aspects of the inventive concept have been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image encoding method comprising:
degrading a quality of a first image which is obtained through a sensor of an imaging device to generate a second image comprising a target resolution;
generating information comprising a transform relationship between the first image and the second image; and
transmitting the information and the second image.

2. The image encoding method of claim 1, wherein the generating the information comprises:
scaling the second image to generate a third image comprising a same resolution as the first image; and
generating, as the information, a differential image between the third image and the first image.

3. The image encoding method of claim 1, wherein the generating the information comprises:
determining a portion of the first image as a region of interest; and
generating, as the information, a transform relationship between the region of interest and a region of the second image that corresponds to the region of interest.

4. The image encoding method of claim 3, wherein the determining the portion comprises determining, as the region of interest, a region of the first image where a degree of restoration representing a matching degree between the first image and an image into which the second image is restored is equal to or less than a value.

5. The image encoding method of claim 3, wherein the determining the portion comprises determining the region of interest according to a user's selection of the region of interest.

6. The image encoding method of claim 3, wherein the determining the portion comprises determining, as the region of interest, a region which comprises an object component.

7. The image encoding method of claim 1, further comprising:
quantizing the generated information; and
compressing the quantized information.

8. The image encoding method of claim 1, further comprising encoding the generated second image prior to the transmitting.

9. An image decoding method comprising:
obtaining a second image which is generated by degrading a quality of a first image which is obtained through a sensor of an imaging device, and information comprising a transform relationship between the first and the second images; and
restoring the second image into the first image according to the information.

10. The image decoding method of claim 9, wherein:
the information comprises a differential image between the first image and a third image which is generated by scaling the second image, and
the restoring the second image comprises:
scaling the second image to obtain the third image; and
restoring the first image by using the third image and the differential image.

11. The image decoding method of claim 9, wherein:
the information comprises a transform relationship between a region of interest being a portion of the first image and a region of the second image that corresponds to the region of interest; and
the restoring the second image comprises restoring the region of the second image according to the information.

12. The image decoding method of claim 11, wherein the region of interest comprises a region where a degree of restoration representing a matching degree between the first image and an image into which the second image is restored is determined to be equal to or less than a value.

13. The image decoding method of claim 11, wherein the region of interest comprises a region which is selected by a user.

14. The image decoding method of claim 11, wherein the region of interest is a region determined to comprise an object component.

15. The image decoding method of claim 9, wherein the restoring the second image comprises:
decompressing the obtained information; and
dequantizing the decompressed information.

16. The image decoding method of claim 9, wherein the restoring the second image comprises decoding the obtained second image.

17. An image encoding apparatus comprising:
a sensor which obtains a first image;
an image generation unit which degrades a quality of the first image to generate a second image;
an information generation unit which generates information comprising a transform relationship between the first and the second images; and
a transmission unit which transmits the information and the second image.

18. The image encoding apparatus of claim 17, further comprising a storage unit which stores the information and the second image.

19. The image encoding apparatus of claim 17, wherein the image encoding apparatus is a digital camera.

20. An image decoding apparatus comprising:
an obtainment unit which obtains a second image which is generated by degrading a quality of a first image which is obtained through a sensor of an imaging device, and information comprising a transform relationship between the first and the second images; and
a restoration unit which restores the second image into the first image according to the information.

21. A computer-readable storage medium storing a program for executing an image encoding method, the computer-readable storage medium executing:
degrading a quality of a first image, which is obtained through a sensor of an imaging device, to generate a second image;
generating information comprising a transform relationship between the first and the second images; and
transmitting the information and the second image.

22. A computer-readable storage medium storing a program for executing an image decoding method, the computer-readable storage medium executing:
obtaining a second image which is generated by degrading a quality of a first image which is obtained through a sensor of an imaging device, and information comprising a transform relationship between the first and the second images; and
restoring the second image into the first image according to the information.

23. An image encoding and decoding method comprising:
degrading, by an image encoding apparatus, a quality of a first image which is obtained through a sensor of an imaging device to generate a second image comprising a target resolution;
generating, by the image encoding apparatus, information comprising a transform relationship between the first image and the second image;
transmitting, by the image encoding apparatus, the information and the second image;
receiving, by an image decoding apparatus, the second image and the information; and
restoring, by the image decoding apparatus, the second image into the first image according to the information.
